(19) United States
(12) Patent Application Publication
(10) Pub. No.: US 2022/0026821 A1
(43) Pub. Date: Jan. 27, 2022

(54) TONER

(71) Applicant: CANON KABUSHIKI KAISHA, Tokyo (JP)

(72) Inventors: Shota Amano, Kanagawa (JP); Takeshi Tsujino, Shizuoka (JP); Junya Asaoka, Shizuoka (JP); Yuu Sasano, Shizuoka (JP); Yuhei Terui, Shizuoka (JP); Koki Inoue, Shizuoka (JP); Shohei Yamashita, Tokyo (JP)

(21) Appl. No.: 17/377,495

(22) Filed: Jul. 16, 2021

(30) Foreign Application Priority Data
Jul. 22, 2020 (JP) 2020-125103

(51) Int. Cl. G03G 9/08; G03G 9/093

(52) U.S. Cl. CPC G03G 9/0819; G03G 9/09307

(57) ABSTRACT

Toner comprising a toner particle comprising a core particle comprising a binder resin and a shell formed on a surface of the core particle, wherein given YA (number %) as an abundance ratio of particles with a particle perimeter of less than 6.332 μm, in a dispersion of the toner treated under the following ultrasound condition A, given XB as an average aspect ratio of the toner and YB (number %) as an abundance ratio of particles with a particle perimeter of less than 6.332 μm, in a dispersion of the toner treated under the following ultrasound condition B, 0.75≤XB≤0.85 and 0.10≤YA−YB≤2.50 are satisfied: where ultrasound condition A: output frequency 30 kHz, output capacity 15 W, ultrasound intensity 100%, exposure time 300 s, and ultrasound condition B: output frequency 30 kHz, output capacity 15 W, ultrasound intensity 5%, exposure time 300 s.

### BACKGROUND OF THE INVENTION

### Field of the Invention

The present disclosure relates to a toner for use in image-forming methods such as an electrophotographic method.

### Description of the Related Art

Normally in an electrophotographic method, the surface of a charged photosensitive member is exposed to form an electrostatic latent image, which is then developed with toner supplied from a developing apparatus to form a toner image on the photosensitive member. A transfer apparatus then transfers this toner image to paper, and the transferred image is fixed to the paper with a fixing apparatus to complete image formation.

Because untransferred toner may remain on the surface of the photosensitive member after the toner image has been transferred to the paper, this untransferred toner needs to be removed before the next image forming process. A common way of removing (clean) such untransferred toner from the surface of the photosensitive member is to bring a cleaning blade made of an elastic material into contact with the surface of the photosensitive member and scrape off the residual toner from the surface of the photosensitive member.

In recent years, reductions in toner particle size are being required to meet demands for higher image quality. The dot reproducibility of the toner image formed on the surface of the photosensitive member can be improved by reducing the particle size of the toner particle.

However, it is known that when such reduced-size toner particles are applied to the image forming method, untransferred toner on the surface of the photosensitive member may not be adequately removed, but instead is likely to slip between the cleaning blade and the photosensitive member. Image defects caused by untransferred toner therefore become a problem.

To solve these problems associated with reduced-size toners, Japanese Patent Application Publication No. 2009-134079 proposes a method for forming images using a toner with an aspect ratio of from 0.8 to 0.9.

### SUMMARY OF THE INVENTION

The inventors conducted diligent research into further increasing the speed and device life (durability) of a developing apparatus using the toner described in Japanese Patent Application Publication No. 2009-134079, and found that although the toner described in Japanese Patent Application Publication No. 2009-134079 has favorable scraping properties due to its low aspect ratio, it is hard to obtain a sufficiently dense blocking layer in the cleaning part. This creates a new problem in which untransferred toner slips through the blocking layer to cause cleaning defects. Thus, further improvements are needed in terms of the cleaning performance.

The toner of the present disclosure is a toner comprising a toner particle comprising
a core particle comprising a binder resin and
a shell formed on a surface of the core particle, wherein

given YA (number %) as an abundance ratio of particles with a particle perimeter of less than 6.332 μm, as measured with a flow particle image measurement apparatus, in a dispersion of the toner treated under the following ultrasound condition A, and

given XB as an average aspect ratio of the toner and YB (number %) as an abundance ratio of particles with a particle perimeter of less than 6.332 μm, as measured with a flow particle image measurement apparatus, in a dispersion of the toner treated under the following ultrasound condition B, formulae (1) and (2) below are satisfied.

0.75≤XB≤0.85 (1)

0.10≤YA−YB≤2.50 (2)

The ultrasound condition A: output frequency 30 kHz, output capacity 15 W, ultrasound intensity 100%, exposure time 300 s

The ultrasound condition B: output frequency 30 kHz, output capacity 15 W, ultrasound intensity 5%, exposure time 300 s

The present disclosure can provide a toner with excellent durability whereby the cleaning problems of an image forming apparatus can be suppressed and high image quality can be maintained.

Further features of the present invention will become apparent from the following description of exemplary embodiments.

### DESCRIPTION OF THE EMBODIMENTS

Embodiments of the present disclosure are explained in detail below.

The toner of the present disclosure is a toner comprising a toner particle comprising
a core particle comprising a binder resin and
a shell formed on a surface of the core particle, wherein

given YA (number %) as an abundance ratio of particles with a particle perimeter of less than 6.332 μm, as measured with a flow particle image measurement apparatus, in a dispersion of the toner treated under the following ultrasound condition A, and

given XB as an average aspect ratio of the toner and YB (number %) as an abundance ratio of particles with a particle perimeter of less than 6.332 μm, as measured with a flow particle image measurement apparatus, in a dispersion of the toner treated under the following ultrasound condition B, formulae (1) and (2) below are satisfied.

0.75≤XB≤0.85 (1)

0.10≤YA−YB≤2.50 (2)

The ultrasound condition A: output frequency 30 kHz, output capacity 15 W, ultrasound intensity 100%, exposure time 300 s

The ultrasound condition B: output frequency 30 kHz, output capacity 15 W, ultrasound intensity 5%, exposure time 300 s

As to why the effects of the present disclosure are obtained when the above conditions are fulfilled, the present inventors believe as follows.

Normally, a toner satisfying formula (1) above is unlikely to form a dense blocking layer in the cleaning part because it has a low average aspect ratio, but if it has a core-shell structure and satisfies formula (2) above, it can form a dense blocking layer in the cleaning part. Formula (2) above is a numerical representation of fine particles derived from the shell that are generated in the cleaning part, and if these fine particles are within the above range, the cleaning performance can be improved by promoting densification of the blocking layer in the cleaning part.

The toner particle has a core having a binder resin and a shell formed on the surface of the core particle. That is, the toner particle has a core-shell structure. The shell of the core-shell structure is partly peeled off in the cleaning part to form the blocking layer. The cleaning performance can thus be improved.

Given XB as the average aspect ratio as measured with a flow particle image measurement apparatus in a dispersion of the toner treated under the following ultrasound condition B, formula (1) below is satisfied.

0.75≤XB≤0.85 (1)

The ultrasound condition B: Output frequency 30 kHz, output capacity 15 W, ultrasound intensity 5%, exposure time 300 s

When formula (1) is satisfied, the cleaning performance (scraping performance) of the untransferred toner are good. The value of XB is preferably from 0.78 to 0.83, or more preferably from 0.79 to 0.82.

If the value of XB is less than 0.75, slip-through occurs because the blocking layer in the cleaning part is not formed densely, leading to cleaning defects. Triboelectric charging also becomes more difficult, and fogging density is likely to increase if the average aspect ratio is too low.

If the value of XB exceeds 0.85, the cleaning performance (scraping performance) of the untransferred toner decline, and cleaning defects occur.

The value of XB can be controlled by changing the core particle manufacturing conditions (number of pulverization steps, classification conditions, etc.).

Given YB (number %) as the abundance ratio of particles with a particle perimeter of less than 6.332 μm as measured with a flow particle image measurement apparatus in a dispersion of the toner treated under the following ultrasound condition B, and YA (number %) as the abundance ratio of particles with a particle perimeter of less than 6.332 μm as measured with a flow particle image measurement apparatus in a dispersion of the toner treated under the following ultrasound condition A, the following formula (2) is satisfied. Particles with a particle perimeter of less than 6.332 μm are hereunder sometimes called “fine particles”, and the abundance ratio of these fine particles is also called the “fine particle ratio”.

0.10≤YA−YB≤2.50 (2)

The ultrasound condition A: Output frequency 30 kHz, output capacity 15 W, ultrasound intensity 100%, exposure time 300 s

The ultrasound condition B: Output frequency 30 kHz, output capacity 15 W, ultrasound intensity 5%, exposure time 300 s.

When formula (2) is satisfied, this means that the blocking layer in the cleaning part is in a dense state. In this state, untransferred toner is unlikely to slip through the cleaning part, resulting in good cleaning performance.

The value of YA−YB is preferably from 0.50 to 2.00, or more preferably from 1.00 to 1.50.

If the value of YA−YB is less than 0.10, this means that not enough fine particles derived from the shell layer are generated in the cleaning part to form a blocking layer.

If the value of YA−YB exceeds 2.50, shell peeling occurs in the image forming process before the blocking layer forms in the cleaning part. The peeled shell and the exposed core therefore adhere to the developing member, causing contamination and particle fusion and leading to image defects called developing streaks.

An effective way of adjusting YA−YB to within the above range is to change the amount of the shell resin added when forming the shell.

Given XA as the average aspect ratio as measured with a flow particle image measurement apparatus in a dispersion of the toner treated under the above ultrasound condition A, preferably the following formula (3) is satisfied.

0.75≤XA≤0.85 (3)

If formula (3) is satisfied, the cleaning performance (scraping performance) of the untransferred toner are further improved. XA is preferably from 0.78 to 0.83, or more preferably from 0.79 to 0.82.

If XA is at least 0.75, slip-through is further suppressed because the blocking layer is formed more densely in the cleaning part, and cleaning problems are further reduced. Triboelectric charging is also easier and long-term fogging density is reduced if the average aspect ratio is not too low.

The value of XA can be controlled by changing the core particle manufacturing conditions (number of pulverization steps, classification conditions, etc.).

The fine particle ratio YB is preferably not more than 60.00 number %, or more preferably not more than 55.00 number %. By reducing the fine particle ratio YB, the developing performance is improved. If it is not more than 60.00 number %, it is possible to suppress fogging due to selective development of fine particles at the beginning of long-term use. The lower limit of YB is not particularly restricted, but is preferably at least 0.00 number %, or more preferably at least 1.00 number %. These numerical ranges may be combined arbitrarily.

The fine particle ratio YA is preferably from 0.10 number % to 62.50 number %, or more preferably from 0.50 number % to 62.00 number %, or still more preferably from 1.00 number % to 61.50 number %. If the fine particle ratio YA is within this range, it is possible to suppress fogging due to selective development of fine particles at the beginning of long-term use. That is, the developing performance is improved.

YA and YB can be controlled by controlling the amount of the shell resin added when forming the shell.

The toner particle preferably contains a surfactant. The ratio of the surfactant on the toner surface is preferably from 5 ppm to 100 ppm, or more preferably from 5 ppm to less than 100 ppm as measured by time-of-flight secondary ion mass spectrometry (hereunder also called TOF-SIMS). If it is at least 5 ppm, it is possible to prevent overcharging and contamination of the members associated with development. If it is not more than 100 ppm, it is possible to prevent charge leakage and reduce the fogging density during long-term use. The ratio of the surfactant on the toner surface can be controlled by controlling the amount of the surfactant used when forming the shell on the surface of the core particle, and by washing so that the conductivity of the washing liquid in the washing step (described below) is from 0.1 μS/cm to 2.0 μS/cm (preferably from 0.2 μS/cm to 1.5 μS/cm).

The ratio of the surfactant on the toner particle surface is measured with a time-of-flight secondary ion mass spectrometer (Iontof GmbH (Germany) Model IV). The range of the toner surface is determined by the time-of-flight secondary ion mass spectrometry conditions as explained below. The range of the toner surface is for example a range extending up to 1 nm towards the toner interior from the toner surface under the measurement conditions of the examples given below. Image mapped data (image data) can be easily obtained by time-of-flight secondary ion mass spectrometry. Consequently, the types of molecules present at each position on the toner surface and the abundances of those molecules can be easily assessed by analyzing the toner surface by time-of-flight secondary ion mass spectrometry.

Binder Resin

The toner particle has a core particle having a binder resin and a shell formed on the surface of the core particle. In other words, the toner particle has a core-shell structure.

The binder resin preferably contains a polyester resin, and preferably consists primarily of a polyester resin from the standpoint of low-temperature fixability. “Consists primary of” here means that the content thereof is from 50 mass % to 100 mass % (preferably from 80 mass % to 100 mass %) of the total. The polyester resin may be either crystalline or amorphous.

A polyhydric alcohol (dihydric or trihydric or higher alcohol) and a polyvalent carboxylic acid (divalent or trivalent or higher carboxylic acid), or acid anhydrides or lower alkyl esters thereof, are used as monomers in the polyester resin.

The following polyhydric alcohol monomers may be used as polyhydric alcohol monomers in the polyester units of the polyester resin.

Examples of dihydric alcohol components include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and the bisphenol represented by formula (A) and derivatives thereof.

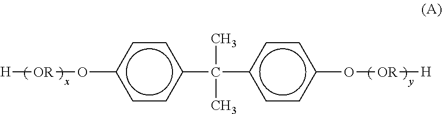

(In the formula, R is an ethylene or propylene group, each of x and y is 0 or an integer greater than 0, and the average value of x+y is from 0 to 10.)

Other examples include the diol represented by formula (B):

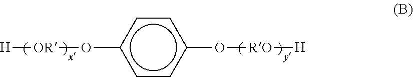

(in the formula, R′ represents:

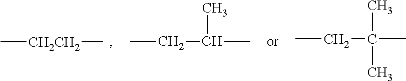

each of x′ and y′ is 0 or an integer greater than 0, and the average value of x′+y′ is from 0 to 10).

Of these, ethylene glycol or the bisphenol represented by formula (A) or a derivative thereof is preferred.

Examples of trihydric and higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylol ethane, trimethylol propane and 1,3,5-trihydroxymethyl benzene.

These dihydric alcohols and trihydric and higher alcohols may be used individually, or multiple kinds may be combined.

The following polyvalent carboxylic acid monomers may be used as the polyvalent carboxylic acid monomer used in the polyester units of the polyester resin.

Examples of divalent carboxylic acid components include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecysuccinic acid, isododecylsuccinic acid, n-octenylsuccinic acid, n-octylsuccinic acid, isooctenylsuccinic acid, isooctylsuccinic acid, and anhydrides thereof and lower alkyl esters of these. Of these, maleic acid, fumaric acid, terephthalic acid and n-dodecenylsuccinic acid may be used by preference.

Examples of trivalent and higher carboxylic acids and their acid anhydrides or lower alkyl esters of these include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid and Empol trimer acid, and acid anhydrides thereof and lower alkyl esters of these.

Of these, 1,2,4-benzenetricarboxylic acid or in other words trimellitic acid and its derivatives are desirable for reasons of cheapness and ease of reaction control. These divalent carboxylic acids and trivalent and higher carboxylic acids may be used individually, or multiple kinds may be combined.

The method for manufacturing the polyester resin is not particularly limited, and a known method may be used. For example, the aforementioned alcohol monomer and carboxylic acid monomer may be charged together and polymerized via an esterification or ester exchange reaction and a condensation reaction to manufacture the polyester resin. The polymerization temperature is not particularly limited, but is preferably in the range of from 180° C. to 290° C. A polymerization catalyst such as a titanium catalyst or tin catalyst or zinc acetate, antimony trioxide, germanium dioxide or the like may also be used. A polyester resin obtained by polymerization using a tin catalyst is particularly desirable as a binder resin.

It is especially desirable that the binder resin contain a polyester resin having monomer units derived from the alcohol component represented by formula (A) above in the amount of from 50.0 mass % to 100.0 mass % (preferably from 80.0 mass % to 100.0 mass %) of the binder resin.

The binder resin may also contain another resin other than the above polyester resin.

The following resins for example may be used as this other resin.

Examples include homopolymers of styrenes and substituted styrenes such as polystyrene, poly-p-chlorostyrene and polyvinyl toluene; styrene copolymers such as styrene-p-chlorostyrene copolymer, styrene-vinyl toluene copolymer, styrene-vinyl naphthalene copolymer, styrene-acrylic acid ester copolymer (styrene-acrylic resin), styrene-methacrylic acid ester copolymer, styrene-α-chloromethyl methacrylate copolymer, styrene-acrylonitrile copolymer, styrene-vinyl methyl ether copolymer, styrene-vinyl ethyl ether copolymer, styrene-vinyl methyl ketone copolymer and styrene-acrylonitrile-indene copolymer; and polyvinyl chloride, phenol resin, natural resin-modified phenol resin, natural resin-modified maleic acid resin, acrylic resin, methacrylic resin, vinyl polyacetate, silicone resin, polyurethane, polyamide resin, furan resin, epoxy resin, xylene resin, polyvinyl butyral, terpene resin, coumarone-indene resin, petroleum resin and the like.

Colorant

The core particle may also contain a colorant. Examples of this colorant include the following.

Examples of black colorants include carbon black and blacks obtained by blending yellow, magenta and cyan colorants. A pigment may be used alone as a colorant, but combining a dye and a pigment to improve sharpness is more desirable from the standpoint of image quality in full-color images.

Examples of magenta coloring pigments include C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C.I. pigment violet 19; and C.I. vat red 1, 2, 10, 13, 15, 23, 29 and 35.

Examples of magenta coloring dyes include oil-soluble dyes such as C.I. solvent red 1, 3, 8, 23, 24, 25, 27, 30, 49, 81, 82, 83, 84, 100, 109 and 121; C.I. disperse red 9; C.I. solvent violet 8, 13, 14, 21 and 27; and C.I. disperse violet 1; and basic dyes such as C.I. basic red 1, 2, 9, 12, 13, 14, 15, 17, 18, 22, 23, 24, 27, 29, 32, 34, 35, 36, 37, 38, 39 and 40; and C.I. basic violet 1, 3, 7, 10, 14, 15, 21, 25, 26, 27 and 28 and the like.

Examples of cyan coloring pigments include C.I. pigment blue 2, 3, 15:2, 15:3, 15:4, 16 and 17; C.I. vat blue 6; C.I. acid blue 45; and copper phthalocyanine pigments having from 1 to 5 phthalimidomethyl groups substituted on the phthalocyanine skeleton.

Examples of cyan coloring dyes include C.I. solvent blue 70.

Examples of yellow coloring pigments include C.I. pigment yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. vat yellow 1, 3 and 20.

Examples of yellow coloring dyes include C.I. solvent yellow 162.

The content of the colorant is preferably from 0.1 to 30.0 mass parts per 100.0 mass parts of the binder resin.

Wax The core particle may contain a wax. The wax is not particularly limited, and examples include the following.

Examples include hydrocarbon waxes such as low-molecular-weight polyethylene, low-molecular-weight polypropyelene, alkylene copolymers, microcrystalline wax, paraffin wax and Fischer-Tropsch wax; hydrocarbon wax oxides such as polyethylene oxide wax, and block copolymers of these; waxes consisting primarily of fatty acid esters, such as carnauba wax; and those such as deoxidized carnauba wax consisting of wholly or partly deoxidized fatty acid esters.

Other examples include the following:

Saturated linear fatty acids such as palmitic acid, stearic acid and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and myricyl alcohol; polyhydric alcohols such as sorbitol; esters of fatty acids such as palmitic acid, stearic acid, behenic acid and montanic acid with alcohols such as stearyl alcohol, aralkyl alcohol, behenyl alcohol, carnaubyl alcohol, ceryl alcohol and myricyl alcohol; fatty acid amides such as linoleamide, oleamide and lauramide; saturated fatty acid bisamides such as methylene bis stearamide, ethylene bis capramide, ethylene bis lauramide and hexamethylene bis stearamide; unsaturated fatty acid amides such as ethylene bis oleamide, hexamethylene bis oleamide, N,N′-dioleyl adipamide and N,N′-dioleyl sebacamide; aromatic bisamides such as m-xylene bis stearamide and N,N′-distearyl isophthalamide; aliphatic metal salts (commonly called metal soaps) such as calcium stearate, calcium laurate, zinc stearate and magnesium stearate; waxes obtained by grafting aliphatic hydrocarbon waxes with vinyl monomers such as styrene and acrylic acid; partial esterified products of fatty acids and polyhydric alcohols, such as behenic acid monoglyceride; and methyl ester compounds having hydroxyl groups obtained by hydrogenation of vegetable oils and fats.

Of these waxes, a hydrocarbon wax such as a paraffin wax or Fischer-Tropsch wax or an ester (ester wax) such as behenyl behenate is desirable for improving low-temperature fixability and wraparound resistance during fixing.

The content of the wax is preferably from 0.5 to 25.0 mass parts per 100.0 mass parts of the binder resin. To achieve both toner storability and hot offset resistance, moreover, the peak temperature of the maximum endothermic peak in the temperature range of 30° C. to 200° C. in an endothermic curve obtained during temperature rise by differential scanning calorimetry (DSC) is preferably from 50° C. to 110° C.

Charge Control Agent

The core particle may also contain a charge control agent as necessary. A known charge control agent may be contained in the core particle. The charge control agent may be either added internally to the core particle or added externally to the toner particle. The content of the charge control agent is preferably from 0.2 to 10.0 mass parts per 100.0 mass parts of the binder resin.

Shell Material

The toner particle has a core particle containing a binder resin and a shell formed on the surface of the core particle.

Various materials such as thermoplastic resins, thermosetting resins and silica fine particles may be used as shell materials. It is desirable to use a thermoplastic resin as the principal component to more easily obtain the effects of the present disclosure.

The thermoplastic resin is preferably a styrene-acrylic resin.

Surfactant

Examples of surfactants that can be contained in the toner particle include cationic surfactants, anionic surfactants and nonionic surfactants. A known surfactant may be used without any particular limitations, but a surfactant having the same polarity as the core particle is preferred.

A cationic surfactant may be a surfactant having a quaternary ammonium group as a hydrophilic group together with a C₁₂₋₂₈ alkyl group as a hydrophobic group for example. Examples of surfactants having quaternary ammonium groups include alkyl trimethylammonium salts, dialkyl dimethylammonium salts and alkylbenzyl dimethylammonium salts.

An anionic surfactant may be a sodium dodecylbenzene sulfonate (Neogen RK made my Daiichi Kogyo Seiyaku Co., Ltd.), for example.

Carrier

To stably obtain images over a long period of time, the toner may also be mixed with a magnetic carrier and used as a two-component developer.

A commonly known magnetic carrier may be used, and examples include surface oxidized iron powders, non-oxidized iron powders, metal particles of iron, lithium, calcium, magnesium, nickel, copper, zinc, cobalt, manganese and rare earths, alloy particles and oxide particles of these, magnetic materials such as ferrite, and magnetic material-dispersed resin carriers (so-called resin carriers) containing magnetic materials together with binders resins for holding the magnetic materials in a dispersed state.

Various methods such as pulverization methods, suspension polymerization methods and agglomeration methods may be used for manufacturing the core particle of the toner. A pulverization method is desirable from the standpoint of simplicity and material selection.

One example of a method for manufacturing the core particle by a pulverization method is explained below.

First, the binder resin and additives such as a wax, a colorant and a charge control agent as necessary are mixed with a stirring apparatus such as a Henschel mixer. The resulting mixture is then melt kneaded and then coarsely crushed and pulverized, and the pulverized product is classified. A toner core particle of the desired particle size can be obtained in this way.

To manufacture a toner particle having the desired particle size and average aspect ratio by a pulverization method, the pulverization step may be performed multiple times such as three or more time with a Turbo Industries Turbomill or the like in such a way that the volume-average particle size (Dv50) declines gradually after each pulverization step.

When the particle is pulverized once with a mechanical pulverizer to the desired particle size, particle size changes during the first part of the pulverization process occur principally because the corners and edges of the core particle are shaved away at the beginning of pulverization, while particle size changes during the latter part of the pulverization process occur principally due to breakage of core particles because the corners of the core particles have already been removed, and the average aspect ratio of the core particles may decline excessively as a result. When pulverization is performed in multiple steps with a mechanical pulverizer, on the other hand, the average aspect ratio of the core particle can be prevented from declining excessively due to breakage of the core particles, and the rate of particle size changes due to shaving of the particle corners can be increased, resulting in a core particle with a relatively large average aspect ratio.

The shell is then formed on the resulting toner core particle.

To satisfy formula (1), it is desirable to that the shell be formed uniformly on the core particle. Therefore, shell formation is preferably performed by adding the shell material dispersed in an aqueous medium to an aqueous solution in which the core particle is thoroughly dispersed.

After the core particle has been added to an aqueous medium, methods for thoroughly dispersing the core particle in the aqueous medium include methods of mechanically dispersing the core particle in the aqueous medium with an apparatus capable of forcibly agitating the dispersion, and methods of dispersing the core particle in an aqueous medium containing a dispersant (a surfactant, an inorganic dispersant or the like).

A method using a surfactant is advantageous for forming the shell without exposing the surface of the core particle because the core particle is uniformly dispersed in the aqueous medium. An example of an apparatus capable of forcibly agitating the dispersion is the Clearmix (registered trademark) high-speed shearing emulsifier CLM-2.2S (M. Technique Co., Ltd).

The shell does not necessarily have to cover the entire surface of the core particle, and the core particle may be exposed in some parts.

The temperature during shell formation is preferably at least 65° C., or more preferably at least 70° C. When the shell is formed within such a temperature range, it is possible to promote good shell formation while suppressing fusion of the formed toner particles with each other.

Once the shell has been formed as described above, the dispersion containing the toner core coated with the shell can be cooled to room temperature to obtain a dispersion of the toner particle. The toner particle can then be washed in a washing step and dried in a drying step as necessary to obtain the toner particle.

In one example of the washing step, the dispersion of the toner particle with the formed shell is subjected to solid-liquid separation, and the separated solids are washed so that the conductivity of the washing liquid is within the specified range. Preferably washing is performed until the conductivity of the washing liquid is from 0.1 μS/cm to 2.0 μS/cm, or more preferably from 0.2 μS/cm to 1.5 μS/cm.

The toner particle may be used as is as a toner, or an external additive may be attached to the surface of the toner particle as necessary. A preferred method for attaching an external additive to the surface of a toner particle obtained by the methods described above is to mix the toner particle and the external additive in a mixer such as an FM Mixer (Nippon Coke & Engineering) with the conditions adjusted so that the external additive does not become embedded in the surface of the toner particle.

The methods for measuring the various physical properties are explained below.

Methods for Measuring Volume-based Median Diameter (Dv50) of Core Particle and Weight-Average Particle Diameter (D4) of Toner Particle

The volume-based median diameter (Dv50) of the core particle and the weight-average particle diameter (D4) of the toner particle are calculated as follows.

A precision particle size distribution measurement apparatus (Multisizer 3 Coulter Counter (registered trademark)) based on the pore electrical resistance method and equipped with a 100 μm aperture tube is used as the measurement apparatus. The dedicated software (Multisizer 3 Version 3.51 software, Beckman Coulter) included with the apparatus is used for setting the measurement conditions and analyzing the measurement data. Measurement is performed with 25,000 effective measurement channels.

The aqueous electrolytic solution used for measurement is a solution of special grade sodium chloride dissolved in deionized water to a concentration of about 1 mass %, such as Beckman Coulter Isoton II (registered trademark).

The following settings are performed on the dedicated software prior to measurement and analysis.

On the “Change Standard Operating Method (SOMME)” screen of the dedicated software, the total count number in control mode is set to 50,000 particles, the number of measurements to 1, and the Kd value to a value obtained using “Standard particles 10.0 μm” (Beckman Coulter). The threshold value and noise level are set automatically by pressing the “Threshold/Noise level measurement” button. The current is set to 1,600 pA, the gain to 2 and the electrolytic solution to Isoton II (registered trademark), and a check is entered for “Aperture flush after measurement”.

On the “Conversion setting from pulse to particle diameter” screen of the dedicated software, the bin interval is set to the logarithmic particle diameter and the particle diameter bins to 256 particle diameter bins, with a particle size range of 2 to 60 μm.

The specific measurement methods are as follows.

(1) About 200 ml of the aqueous electrolytic solution is placed in a 250 ml glass round-bottomed beaker dedicated to the Multisizer 3, and this is set in the sample stand, and stirred counter-clockwise with the stirrer rod at a rate of 24 rotations per second. Contamination and air bubbles in the aperture tube are then removed by the “Aperture flush” function of the dedicated software.

(2) About 30 ml of the aqueous electrolytic solution is placed in a 100 ml glass flat-bottomed beaker, and about 0.3 ml of a diluted solution of “Contaminon N” (a 10 mass % aqueous solution of a pH 7 neutral detergent for cleaning precision measurement instruments, comprising a non-ionic surfactant, an anionic surfactant and an organic builder, manufactured by Wako Pure Chemical Industries) diluted 3 times by mass with deionized water is added thereto as a dispersant.

(3) An ultrasound disperser with an electrical output of 120 W equipped with two oscillators with an oscillation frequency of 50 kHz built in with their phases shifted by 180 degrees (Ultrasonic Dispersion System Tetra 150, Nikkaki Bios) is prepared. About 3.3 L of deionized water is placed in the water tank of the ultrasound disperser, and about 2 ml of Contaminon N (registered trademark) is then added to the water tank

(4) The beaker of (2) above is set in the beaker fixing hole of the ultrasound disperser, and the ultrasound disperser is operated. The vertical position of the beaker is adjusted so as to maximize the resonance state of the surface of the electrolytic solution in the beaker.

(5) About 10 mg of the core particle or toner particle is added bit by bit and dispersed in the aqueous electrolytic solution in the beaker of (4) above as the aqueous electrolytic solution is exposed to ultrasound. Ultrasound dispersion is then continued for another 60 seconds. The water temperature of the water tank is adjusted appropriately so as to be from 10° C. to 40° C. during ultrasound dispersion.

(6) The aqueous electrolytic solution of (5) above containing the dispersed toner particle is dripped with a pipette into the round-bottomed beaker of (0) above set in the sample stand to adjust the measurement concentration to 5%. Measurement is then performed until the number of measured particles reaches 50,000.

(7) The measurement data are analyzed with the above dedicated software included with the apparatus to calculate the volume-based median diameter (Dv50) and the weight-average particle diameter (D4).

Methods for Measuring Average Aspect Ratios (XA, XB) and Fine Particle Ratios (YA, YB)

The average aspect ratios (XA, XB) and fine particle ratios (YA, YB) of the core particle or the toner particle are measuring with a FPIA-3000 flow particle image analyzer (Sysmex) under the measurement and analysis conditions for calibration operations.

The specific measurement methods are as follows. First, 10 ml of deionized water from which solid impurities have been removed is placed in a glass vessel. About 0.5 ml of a diluted solution of Contaminon N (a 10 mass % aqueous solution of a pH 7 neutral detergent for cleaning precision measurement instruments, comprising a nonionic surfactant, an anionic surfactant and an organic builder, manufactured by Wako Pure Chemical Industries) diluted 3 times by mass with deionized water is added thereto as a dispersant. 0.02 g of the measurement sample is then added and stirred while being dispersed for five minutes with an ultrasound disperser to obtain a dispersion for measurement. Cooling is performed appropriately during this process so that the temperature of the dispersion is from 10° C. to 40° C. Using an ultrasound homogenizer with an oscillation frequency of 30 kHz and electrical output of 15 W (FPIA-3000 ultrasound dispersion unit, manufactured by Sysmex) as the ultrasound disperser, 1.0 cm of the vibrating part is immersed in the dispersion, and vibrated with an output energy of 5% (ultrasound condition B) or 100% (ultrasound condition A).

Measurement is performed using a “LUCPLFLN” objective lens (magnification 20×, aperture 0.40) mounted on the above flow particle image analyzer, with Particle Sheath PSE-900A (Sysmex) as the sheath liquid. A dispersion prepared by the above procedures is introduced into the flow particle image analyzer, and 2,000 core particles or toner particles are measured in HPF measurement mode, total count mode. The binarization threshold was set at 85% during particle analysis, and the analyzed particle sizes (defined as the particle perimeters) were limited to 6.332 μm to less than 400.0 μm. The aspect ratio (X) is the aspect ratio of particles 6.332 μm or more in size, and the fine particle ratio (Y) is the abundance ratio of particles less than 6.332 μm in size. The aspect ratio is defined as follows.

Aspect ratio=(maximum length perpendicular to maximum length)/(maximum length)

The average aspect ratio is here given as XA and the fine particle ratio as YA when measured using a dispersion treated under the ultrasound condition A. Similarly, the average aspect ratio is given as XB and the fine particle ratio as YB when measured using a dispersion treated under the ultrasound condition B.

Prior to the beginning of measurement, automatic focal point adjustment is performed using standard latex particles (Duke Scientific “Research and Test Particles Latex Microsphere Suspensions 5100A”, diluted with deionized water). Subsequently, focal point adjustment is performed every two hours after the start of measurement.

A flow particle image analyzer that had been calibrated by Sysmex Corp. and had received a calibration certificate issued by Sysmex Corp was used in the examples of the application. Measurement was performed under the measurement and analysis conditions used for calibration certification except that the analyzed particle sizes are limited to particle perimeters of from 6.332 μm to less than 400.0 μm.

Ratio of Surfactant Amount on Toner Surface Measurement is performed under the following conditions using a time-of-flight secondary ion mass spectrometer (Iontof GmbH Model IV).

A sample (toner) is fixed to double-sided tape and set on the sample holder of the above time-of-flight secondary ion mass spectrometer. The sample in the sample holder is exposed to a primary ion beam under conditions of primary ion species Bi³⁺, acceleration voltage of 25 kV and irradiation current 0.1 pA. The secondary ions emitted by the sample when it is exposed to the primary ion beam are collected for a cumulative time of 30 seconds (10 scans) with a 50 nm square visual analysis field. A mass spectrum of secondary ions is measured in this way.

The mass spectra of 10 visual fields are measured for each kind of sample. A calibration curve is prepared using standardized samples. The calibration curve is used to standardize the mass spectra, after which the amount of ions derived from the surfactant is obtained. The average ion amount is then obtained from the resulting ion amounts. The resulting average ion amount is given as the ratio of the surfactant amount on the toner surface. The absolute calibration curve method is adopted as the method for preparing the calibration curve.

### EXAMPLES

The present disclosure is explained in more detail below using examples. The examples below do not limit the present disclosure. Unless otherwise specified, parts in the examples and comparative examples are all based on mass.

Manufacturing Example of Polyester Resin 1 for Core Resin

85.0 parts of terephthalic acid, 16.4 parts of trimellitic anhydride, 123.3 parts of bisphenol A and 14.1 parts of ethylene glycol were added to a reactor equipped with a stirrer, a thermometer, a nitrogen introduction pipe, a dewatering pipe and a decompression unit, and heated to 130° C. under stirring. 0.5 parts of titanium (IV) isopropoxide were added as an esterification reagent, after which the temperature was raised to 160° C. and polycondensation was performed for five hours. The temperature was then raised to 180° C., and the pressure was reduced as the mixture was reacted until the desired molecular weight was reached to obtain a polyester resin 1.

Manufacturing Example of Styrene-Acrylic Resin for Core Resin

80.0 parts of styrene, 20.0 parts of n-butyl acrylate and 0.3 parts of hexanediol diacrylate were added to a reactor equipped with a stirrer, a thermometer and a nitrogen introduction pipe, and heated to 80° C. under stirring.

2.0 parts of perbutyl O (10-hour half-life temperature 72.1° C., made by NOF) were then added as a polymerization initiator, and the mixture was polymerized for five hours to obtain a styrene-acrylic resin for the core resin.

Manufacturing Example of Water-Based Dispersion of Shell Resin 1

79.6 parts of styrene, 19.5 parts of n-butyl acrylate and 0.9 parts of ethylene glycol dimethacrylate were added to an aqueous solution of 3.0 parts of the surfactant Neogen RK (made my Daiichi Kogyo Seiyaku Co., Ltd.) dissolved in 50 parts of deionized water, and dispersed. This was then stirred slowly for 10 minutes as an aqueous solution of 0.3 parts of potassium persulfate dissolved in 10 parts of deionized water was added. The system was purged with nitrogen, after which esterification polymerization was performed for six hours at 70° C. After completion of polymerization, the reaction solution was cooled to room temperature, and deionized water was added to obtain an aqueous dispersion of a shell resin 1 with a solids concentration of 50.0 mass %.

Manufacturing Example of Toner 1
Manufacturing Example of Core Particle 1

| | |
|---|---|
| Polyester 1 | 90.0 parts |
| Styrene-acrylic resin for core resin | 10.0 parts |
| C.I. pigment blue 15:3 (copper phthalocyanine) | 5.0 parts |
| Ester wax (behenyl behenate: melting point 72° C.) | 15.0 parts |
| Fischer-Tropsch wax (Sasol C105, melting point: 105° C.) | 2.0 parts |

These materials were pre-mixed with a Mitsui Henschel mixer (Mitsui Mikke) and then melt kneaded with a twin-screw extruder (product name PCM-30, Ikegai Corp.) with the temperature set so that the temperature of the melted product at the ejection port was 140° C.

The melt kneaded product was crushed with a crusher (Rotoplex, Toa Kikai) to obtain a crushed product with a volume-average particle size (Dv50) of 20 μm. The crushed product was then finely pulverized in six stages with a mechanical pulverizer (Turbomill, Turbo Industries) to obtain a pulverized product.

The pulverized product was then classified with a classifier (Elbojet, Nittetsu Mining Co.) to obtain a core particle 1 with a volume-average particle size (Dv50) of 6.7 μm.

Core Particles 2 to 7

Core particles 2 to 7 with different average aspect ratios were obtained by changing the pulverization conditions as shown in Table 1 in the manufacturing method of the core particle 1. The fine particle ratio was adjusted by changing the classifying conditions.

TABLE 1

| | | Particle | Average | Fine |
|---|---|---|---|---|
| | | size | aspect | particle |
| | Number of | Dv50 | ratio | ratio |
| Core particle | pulverizations | (μm) | (—) | (number %) |
| Core particle 1 | 6 | 6.7 | 0.82 | 15.1 |
| Core particle 2 | 1 | 6.8 | 0.75 | 22.5 |
| Core particle 3 | 9 | 6.6 | 0.85 | 11.2 |
| Core particle 4 | 4 | 6.6 | 0.81 | 35.6 |
| Core particle 5 | 2 | 6.7 | 0.79 | 40.3 |
| Core particle 6 | 1 | 6.9 | 0.70 | 18.2 |
| Core particle 7 | 12 | 6.6 | 0.90 | 19.0 |

The average aspect ratios and fine particle ratios in Table 1 are values obtained by measuring a dispersion of each core particle treated under the following ultrasound condition B with a flow particle image measurement apparatus.

The ultrasound condition B: output frequency 30 kHz, output capacity 15 W, ultrasound intensity 5%, exposure time 300 s

Manufacturing Toner Particle 1

0.25 parts of sodium lauryl sulfate were added to 250.0 parts of deionized water heated to 40° C. and stirred at a stirring speed of 15,000 rpm with a Clearmix registered trademark) CLM-2.2S (M-Technique) to prepare an aqueous medium.

100.0 parts of the core particle 1 were added to the aqueous medium to prepare a slurry of the core particle 1.

10.0 parts of an aqueous dispersion of the shell resin 1 with a solids concentration of 50.0 mass % were then added so as to add 5.0 parts of the shell resin 1 per 100.0 parts of the core particle 1, and the temperature was raised to 75° C. and maintained for two hours to form a shell on the surface of the core particle.

After being cooled to room temperature, the dispersion was subjected to solid-liquid separation, and the separated solids were washed until the wash liquid had a conductivity of 0.7 μS/cm, and then dried. A toner particle 1 with a weight-average particle size (D4) of 6.7 μm was obtained as a result.

Manufacturing Toner 1

100.0 parts of the toner particle 1 and 1.5 part of a dry silica particle (Aerosil (registered trademark) REA90, manufactured by Nippon Aerosil, positive charged hydrophobized silica particle) were mixed for three minutes with an FM Mixer (Nippon Coke & Engineering) to attach the silica particle to the toner particle 1. This was then sieved with a 300 #mesh (48 μm mesh) to obtain a toner 1.

Manufacturing Toners 2 to 15

Toners 2 to 15 were obtained as in the manufacturing example of the toner 1 except that the types of core particles used, the added parts of the shell and the conditions after washing were changed as shown in Table 2.

TABLE 2

| | | Added | Conditions for | Average aspect | | Fine particle ratio | | | Surfactant |
|---|---|---|---|---|---|---|---|---|---|
| | Core | parts of | finishing washing | ratio (−) | | (number %) | | YA − | ratio |
| | particle | shell resin | (μS/cm) | XA | XB | YA | YB | YB | (ppm) |
| Toner 1 | 1 | 5.0 | 0.7 | 0.82 | 0.82 | 41.60 | 40.10 | 1.50 | 50 |
| Toner 2 | 2 | 5.0 | 0.7 | 0.75 | 0.75 | 47.30 | 45.60 | 1.70 | 51 |
| Toner 3 | 3 | 5.0 | 0.7 | 0.85 | 0.85 | 34.00 | 32.80 | 1.20 | 50 |
| Toner 4 | 1 | 2.0 | 0.7 | 0.82 | 0.82 | 22.40 | 22.30 | 0.10 | 52 |
| Toner 5 | 1 | 7.0 | 0.7 | 0.83 | 0.83 | 55.90 | 53.40 | 2.50 | 51 |
| Toner 6 | 1 | 5.0 | 0.2 | 0.82 | 0.82 | 53.10 | 51.60 | 1.50 | 5 |
| Toner 7 | 1 | 5.0 | 1.2 | 0.82 | 0.82 | 43.80 | 42.20 | 1.60 | 100 |
| Toner 8 | 1 | 5.0 | 0.1 | 0.82 | 0.82 | 42.30 | 40.90 | 1.40 | 4 |
| Toner 9 | 1 | 5.0 | 1.9 | 0.82 | 0.82 | 45.20 | 43.70 | 1.50 | 150 |
| Toner 10 | 4 | 5.0 | 0.7 | 0.81 | 0.81 | 61.50 | 60.00 | 1.50 | 50 |
| Toner 11 | 5 | 5.0 | 0.7 | 0.79 | 0.79 | 67.00 | 65.40 | 1.60 | 49 |
| Toner 12 | 1 | 0.0 | 0.7 | 0.82 | 0.82 | 15.35 | 15.30 | 0.05 | 0 |
| Toner 13 | 6 | 5.0 | 0.7 | 0.70 | 0.70 | 20.10 | 18.60 | 1.50 | 51 |
| Toner 14 | 7 | 5.0 | 0.7 | 0.90 | 0.90 | 20.90 | 19.40 | 1.50 | 56 |
| Toner 15 | 1 | 10.0 | 0.7 | 0.82 | 0.82 | 56.10 | 53.10 | 3.00 | 57 |

Image Evaluation

Image evaluation was performed using a commercial color laser printer (Kyocera Document Solutions Inc. FS-C5250DN) that had been modified so that it could operate with only a single-color process cartridge installed, and so that the temperature of the fixing unit could be changed at will. A two-component developer prepared by the methods described below was inserted into the developing part of the evaluation unit, the toner container of the evaluation unit was filled with a toner of the same kind as the toner used to prepare the two-component developer, and the following image evaluations were performed.

Preparing Two-Component Developer

100 parts of a developer carrier (carrier for FS-C5250DN) and 10 parts of the toner were mixed for 30 minutes with a ball mill to prepare a two-component developer. Specific image evaluation items are as follows.

Cleaning Performance

A solid image (toner laid-on level 0.9 mg/cm²) was formed on a transfer material, after which a white image was immediately formed and observed visually to evaluate toner slip-through. Letter size plain paper (Xerox 4200, Xerox Co., 75 g/m²) was used as the transfer material. If the evaluation result is A, B or C, the effects of the present disclosure are judged to have been obtained.

Evaluation Standard

A: No slip-through
B: Vertical streaks due to toner slip-through in 1 to 3 locations on white image
C: Vertical streaks due to toner slip-through in 4 to 6 locations on white image
D: Vertical streaks due to toner slip-through in 7 or more locations on white image, or vertical streaks at least 0.5 mm in width in at least one location

Developing Streaks

3,000 sheets of a horizontal line image with a print percentage of 1% were printed out in a high-temperature high-humidity environment (32° C./85% RH), and after completion of this test a halftone image (toner laid-on level 0.3 mg/cm²) was printed out on letter size Xerox 4200 paper (Xerox Co., 75 g/m²), the presence or absence of vertical streaks in the paper discharge direction on the halftone image was observed, and durability was evaluated as follows. If the evaluation result is A, B or C, the effects of the present disclosure are judged to have been obtained.

Evaluation Standard

A: No streaks
B: Vertical streaks in 1 to 3 locations in direction of paper discharge on halftone part of image
C: Vertical streaks in 4 to 6 locations in direction of paper discharge on halftone part of image
D: Vertical streaks in 7 or more locations in direction of paper discharge on halftone part of image, or vertical streaks at least 0.5 mm in width in at least one location

Initial Fogging, Storage Fogging

The evaluation was performed in a high-temperature high-humidity (32° C./85% RH) environment. At the beginning of long-term use an image having a white part was output, and the fogging concentration (%) was calculated and initial fogging was evaluated based on the difference between the whiteness of the white part of the output image as measured with a Model TC-6DS Reflectometer (Tokyo Denshoku) and the whiteness of the evaluation paper. An amber light filter was used as the filter.

An endurance test was then performed by outputting 30,000 sheets of an image with a print percentage of 1.0% with a 2-second interval between each two sheets. After 30,000 images had been output, the machine was turned off and the developing device was left inside the machine for 72 hours in the same environment. The machine was then turned on again and fogging density (%) was calculated in the same way as initial fogging density and used to evaluate storage fogging. An amber light filter was used as the filter.

The evaluation standard was set as follows, with smaller numbers indicating that image fogging has been suppressed. The evaluation was performed on plain paper (HP Brochure Paper 200 g, Glossy, HP Co., 200 g/m²) in gloss paper mode. If the evaluation result is A, B or C, the effects of the present disclosure are judged to have been obtained.

Evaluation Standard

A: Less than 2.0
B: 2.0 to less than 3.0
C: 3.0 to less than 4.0
D: At least 4.0

### Examples 1 to 11

In Examples 1 to 11, the above evaluations were performed using the toners 1 to 11 as the toners, respectively. The evaluation results are shown in Table 3.

### Comparative Examples 1 to 4

In Comparative Examples 1 to 4, the above evaluations were performed using the toners 12 to 15 as the toners, respectively. The evaluation results are shown in Table 3.

TABLE 3

| | | Cleaning | Developing | | | | |
|---|---|---|---|---|---|---|---|
| | | performance | streaks | Initial fogging | | Storage fogging | |
| | Toner | Rank | Rank | Rank | Fogging density | Rank | Fogging density |
| Example 1 | Toner 1 | A | A | A | 0.5 | A | 0.3 |
| Example 2 | Toner 2 | B | A | B | 2.1 | B | 2.2 |
| Example 3 | Toner 3 | B | B | A | 0.4 | A | 0.5 |
| Example 4 | Toner 4 | C | A | A | 0.5 | A | 0.6 |
| Example 5 | Toner 5 | A | B | A | 0.3 | A | 0.4 |
| Example 6 | Toner 6 | A | B | A | 0.5 | A | 0.6 |
| Example 7 | Toner 7 | A | A | B | 2.3 | B | 2.5 |
| Example 8 | Toner 8 | A | C | A | 0.6 | A | 0.5 |
| Example 9 | Toner 9 | A | A | C | 3.4 | B | 2.7 |
| Example 10 | Toner 10 | A | A | B | 2.1 | A | 1.1 |
| Example 11 | Toner 11 | A | A | C | 3.1 | A | 0.6 |
| Comparative Example 1 | Toner 12 | D | A | A | 1.1 | A | 1.2 |
| Comparative Example 2 | Toner 13 | D | A | D | 4.5 | D | 4.1 |
| Comparative Example 3 | Toner 14 | D | D | A | 0.3 | A | 0.5 |
| Comparative Example 4 | Toner 15 | A | D | B | 2.2 | A | 1.3 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-125103, filed Jul. 22, 2020 which is hereby incorporated by reference herein in its entirety.

What is claimed is:

1. A toner comprising a toner particle comprising
a core particle comprising a binder resin and
a shell formed on a surface of the core particle, wherein
given YA (number %) as an abundance ratio of particles with a particle perimeter of less than 6.332 μm, as measured with a flow particle image measurement apparatus, in a dispersion of the toner treated under the following ultrasound condition A, and
given XB as an average aspect ratio of the toner and YB (number %) as an abundance ratio of particles with a particle perimeter of less than 6.332 μm, as measured with a flow particle image measurement apparatus, in a dispersion of the toner treated under the following ultrasound condition B, formulae (1) and (2) below are satisfied:
0.75≤XB≤0.85 (1)
0.10≤YA−YB≤2.50 (2)
where
the ultrasound condition A: output frequency 30 kHz, output capacity 15 W, ultrasound intensity 100%, exposure time 300 s, and
the ultrasound condition B: output frequency 30 kHz, output capacity 15 W, ultrasound intensity 5%, exposure time 300 s.

2. The toner according to claim 1, wherein given XA as an average aspect ratio of the toner, as measured with a flow particle image measurement apparatus, in a dispersion of the toner treated under the ultrasound condition A, formula (3) below is satisfied:
0.75≤XA≤0.85 (3).

3. The toner according to claim 1, wherein the YB is not more than 60.00 number %.

4. The toner according to claim 2, wherein the YB is not more than 60.00 number %.

5. The toner according to claim 1, wherein the toner particle comprises a surfactant.

6. The toner according to claim 2, wherein the toner particle comprises a surfactant.

7. The toner according to claim 3, wherein the toner particle comprises a surfactant.

8. The toner according to claim 4, wherein the toner particle comprises a surfactant.

9. The toner according to claim 5, wherein the surfactant is contained in the shell.

10. The toner according to claim 6, wherein the surfactant is contained in the shell.

11. The toner according to claim 7, wherein the surfactant is contained in the shell.

12. The toner according to claim 8, wherein the surfactant is contained in the shell.

13. The toner according to claim 5, wherein a ratio of the surfactant in the surface of the toner is 5 to 100 ppm as measured by time-of-flight second ion mass spectrometry (TOF-SIMS).

14. The toner according to claim 6, wherein a ratio of the surfactant in the surface of the toner is 5 to 100 ppm as measured by time-of-flight second ion mass spectrometry (TOF-SIMS).

15. The toner according to claim 7, wherein a ratio of the surfactant in the surface of the toner is 5 to 100 ppm as measured by time-of-flight second ion mass spectrometry (TOF-SIMS).

16. The toner according to claim 8, wherein a ratio of the surfactant in the surface of the toner is 5 to 100 ppm as measured by time-of-flight second ion mass spectrometry (TOF-SIMS).

17. The toner according to claim 9, wherein a ratio of the surfactant in the surface of the toner is 5 to 100 ppm as measured by time-of-flight second ion mass spectrometry (TOF-SIMS).

18. The toner according to claim 10, wherein a ratio of the surfactant in the surface of the toner is 5 to 100 ppm as measured by time-of-flight second ion mass spectrometry (TOF-SIMS).

19. The toner according to claim 11, wherein a ratio of the surfactant in the surface of the toner is 5 to 100 ppm as measured by time-of-flight second ion mass spectrometry (TOF-SIMS).

20. The toner according to claim 12, wherein a ratio of the surfactant in the surface of the toner is 5 to 100 ppm as measured by time-of-flight second ion mass spectrometry (TOF-SIMS).
